(19) United States
(12) Patent Application Publication
(10) Pub. No.: US 2004/0100386 A1
(43) Pub. Date: May 27, 2004

(54) Animal selective pet door

(76) Inventor: Robert K. Tendler, Chestnut Hill, MA (US)

Correspondence Address: Robert K. Tendler, 65 Atlantic Avenue, Boston, MA, 02110, US

(21) Appl. No.: 10/302,012

(22) Filed: Nov. 22, 2002

(51) Int. Cl. G08B 23/00

(52) U.S. Cl. 340/573.3; 340/5.7

(57) ABSTRACT

An automatically opening and closing dog or other pet door is provided with a mechanism to open the door responsive to the presence of an animal to either side of the door along with a transmitted electronic code which identifies that the animal is authorized for entry and exit. In one embodiment, an ultrasonic sensor is utilized along with a transponder on the dog's collar to indicate the presence of authorized pet. Alternatively, a proximity sensing device is utilized which senses the proximity of an activated transponder which when pinged transmits the fact of the presence of the animal within a predetermined range of the door and also the animal's identification number. Detection circuitry adjacent the door detects the presence of the animal by a proximity sensor and the identity of the animal through a transmitted code. This effectively bars entry from those who seek to use the pet door, be they other animals or human beings, with the door being secured against the weather, unlike flap type pet doors, with the subject system preventing unauthorized entry of non-authorized pets or animals. This prevents the unauthorized entry of squirrels, skunks, stray cats and other unauthorized animals through the pet door while at the same time sealing the door against the elements.

### FIELD OF INVENTION

This invention relates to automatic pet doors more particularly to a pet door that is actuated due to the proximity of an authorized animal.

### BACKGROUND OF THE INVENTION

Pet doors with flexible flaps have been known in which the flexible flap is held in place by a frame through the door, with the animal entering and exiting the premises by pushing on the flap. For some animals, it is impossible to train the animal to push against the flap, leaving the problem of either keeping the flap open permanently or not using the flap type pet door.

Additionally, the sealing afforded by movable flaps or flexible flaps against the elements does not provide the required barrier for instance for cold weather from penetrating into the area at which the pet door is located.

Perhaps more importantly, those doors which are passive in the sense of having the flap pushed by the animal are breachable by animals such as stray cats, skunks, squirrels and other rodents who can enter the premises through pushing on the flap.

These flap type doors are secured in most instances by blocking the orifice defined by the flap. However, this prevents authorized pets from entering and exiting the premises and in part eliminates the reason for having a pet door, and that is to permit unattended access to the premises and egress from the premises.

It will also be appreciated that motion sensors or other proximity sensors have been utilized in the past with respect to automatically operating doors such as entrance to supermarkets and the like. However, these doors can be activated by any moving or stationary animal such that entrance to the premises is not effectively controlled.

Moreover, in some instances the pet doors are of sufficient size that a human being can crawl through the pet door, thereby precluding security to the interior of the premises when such doors are utilized.

### SUMMARY OF THE INVENTION

Rather than relying on a passive system with a flexible flap over the portal entrance, and rather than relying on a light beam actuated proximity sensor for opening and closing a door, in the subject system, a mechanically operated door coupled to a proximity sensing system is activated only when a collar on the pet having a coded transmitter or transponder indicates the presence of that particular pet within the proximity of the door. In one embodiment, an ultrasonic sensor is utilized which when the pet is within a predetermined range activates a transponder on the pet collar to transmit a coded signal to the pet detection device at the door indicating the presence of an authorized animal. The authorized animal may either be in the residence or building structure, or outside of the residence or building structure. In either case the door is only opened in response to the transmission from the animal of a predetermined code.

This prevents, for instance, unauthorized entry of animals outside the dwelling such as the aforementioned skunks, stray cats, rodents or other creatures, while at the same time permitting authorized pets entrance and egress.

The subject system also permits use of a weather proof thermally insulated door as opposed to a flexible flap to seal the portal from the elements, whether it be keeping cold air from coming in or in the summertime, cold air from going out.

The subject system is also secure against unauthorized entry through the door when the door is in its closed position, unlike the flexible flap pet doors mentioned above.

Whether the transponder on the pet is continuously transmitting its code, with proximity sensed by the level of the signal received, or whether the animal is sensed by ultrasonic or electric eye means and the pet's unique identification number transmitted, upon proximity sensing the result is the same. Only authorized pets activate the door opening mechanism so as to permit ingress and egress for the pet. The result is that pets can be accommodated in unattended fashion, whereas unauthorized intruders, either human or animal, are prevented from entering the dwelling. Additionally, since the door is of a weatherproof variety, temperature control within the dwelling is easily established since the door is for the most part always closed, except when activated by the authorized pet.

In summary, an automatically opening and closing dog or other pet door is provided with a mechanism to open the door responsive to the presence of an animal to either side of the door along with a transmitted electronic code which identifies that the animal is authorized for entry and exit. In one embodiment, an ultrasonic sensor is utilized along with a transponder on the dog's collar to indicate the presence of authorized pet. Alternatively, a proximity sensing device is utilized which senses the proximity of an activated transponder which when pinged transmits the fact of the presence of the animal within a predetermined range of the door and also the animal's identification number. Detection circuitry adjacent the door detects the presence of the animal by a proximity sensor and the identity, of the animal through a transmitted code. This effectively bars entry from those who seek to use the pet door, be they other animals or human beings, with the door being secured against the weather, unlike flap type pet doors, with the subject system preventing unauthorized entry of non-authorized pets or animals. This prevents the unauthorized entry of squirrels, skunks, stray cats and other unauthorized animals through the pet door while at the same time sealing the door against the elements.

### BRIEF DESCRIPTION OF THE DRAWINGS

These and other features of the subject invention will be better understood in connection with the Detailed Description in conjunction with the Drawings, of which:

FIG. 1 is diagrammatic representation of the subject invention illustrating the automatic opening of a door through the detection of the proximity of an authorized animal in the vicinity to either side thereof, and a signal transmission system having one of its elements connected to the collar of the pet to transmit a predetermined code which when decoded results in the actuation of the motor to open the door;

FIG. 2 is a block diagram of an alternative embodiment to the system of FIG. 1, in which a range sensitive proximity detector is utilized to detect the presence of an authorized pet when the pet is in for instance the immediate vicinity of the door as detected by the amplitude of the transmitted signal therefrom with the door being activated upon decoding of the appropriate code transmitted by the pet;

FIG. 3 is diagrammatic illustration of an alternative authorized pet detection system in which the interception of a light beam by the animal causes the transmitter on the collar of the animal to generate a coded signal which when decoded activates the motor for opening the door, also showing a broken beam light detector operating in combination with the decoded signal from the pet for fail safe operation of the activation of the motor controlling the opening of the door; and,

FIG. 4 is a diagrammatic illustration of a transponder embodiment of the subject invention.

### DETAILED DESCRIPTION

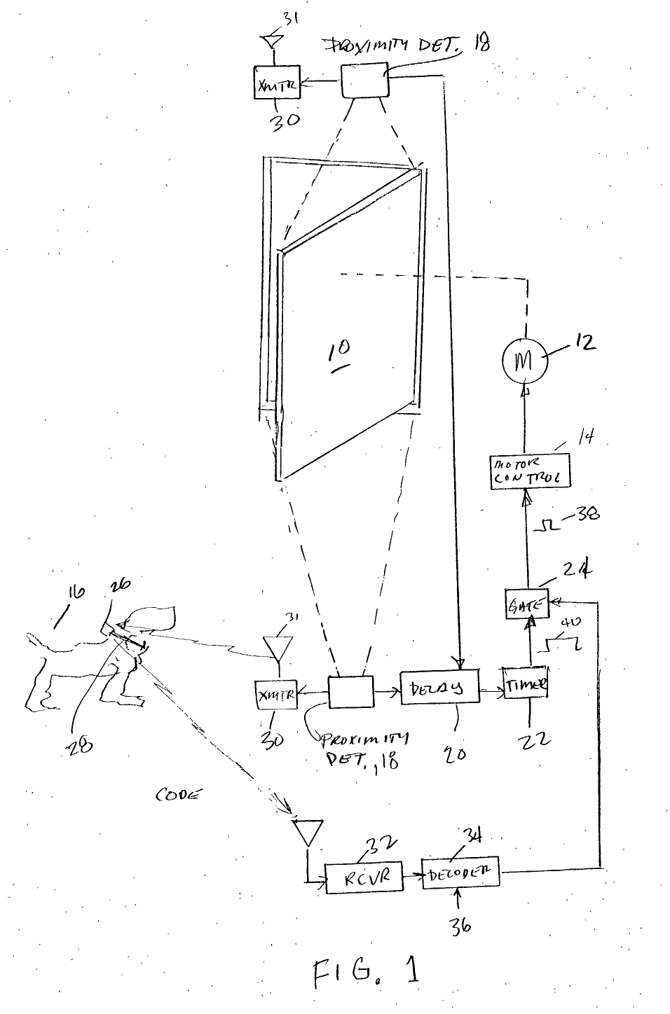

Referring now to FIG. 1, a door 10 is actuated by a motor 12 to open the door in response from a signal from a motor control unit 14.

The door is to be opened when a pet, here illustrated at 16, is detected by a proximity detector 18 to be in the vicinity of the door. In one embodiment, the proximity detector may be an ultrasonic detector or, as will be described, may be an interrupted light beam detection system.

In the illustrated embodiment, a proximity detector is placed to either side of the door for to detection of a pet either outside a dwelling or inside the dwelling. These detectors are illustrated by proximity detectors 18 which are turn in one embodiment coupled to a delay circuit 20 coupled to a timer 22, which is in turn coupled to a gate 24 coupled to a motor control unit 14.

A coded transmission comes from a transmitter 26 located on a collar 28 which is worn by the pet, with transmitter 26 in one embodiment activated by signals transmitted by a transmitter 30 to a receiver 32 which receives the coded transmitted signals. The signals are decoded at 34 and assuming that the appropriate code has been entered as illustrated by arrow 36, a signal is provided to gate 24 which when combined or ANDed with the output from timer 22 results in a pulse 38 that is utilized by motor control unit 14 to power motor 12 to open door 10.

Delay 20 is not necessary, but may be utilized to delay the opening of the door over a predetermined time pending on the distance between the sensed object and the door. Timer 22 is utilized to provide a timing or gating signal 40 so that the motor control unit is operational for the length of time set by timer 22.

It will be appreciated that in the embodiment of FIG. 1, the transmitter worn by the pet is only activated when pinged by transmitter 30 through radiation from its antenna 31 such that transmitter 30 is only turned on when proximity detector 18 detects the presence of the pet in the vicinity of the door. This minimizes the amount of power drain for the unit carried by the animal so as not to run down the batteries.

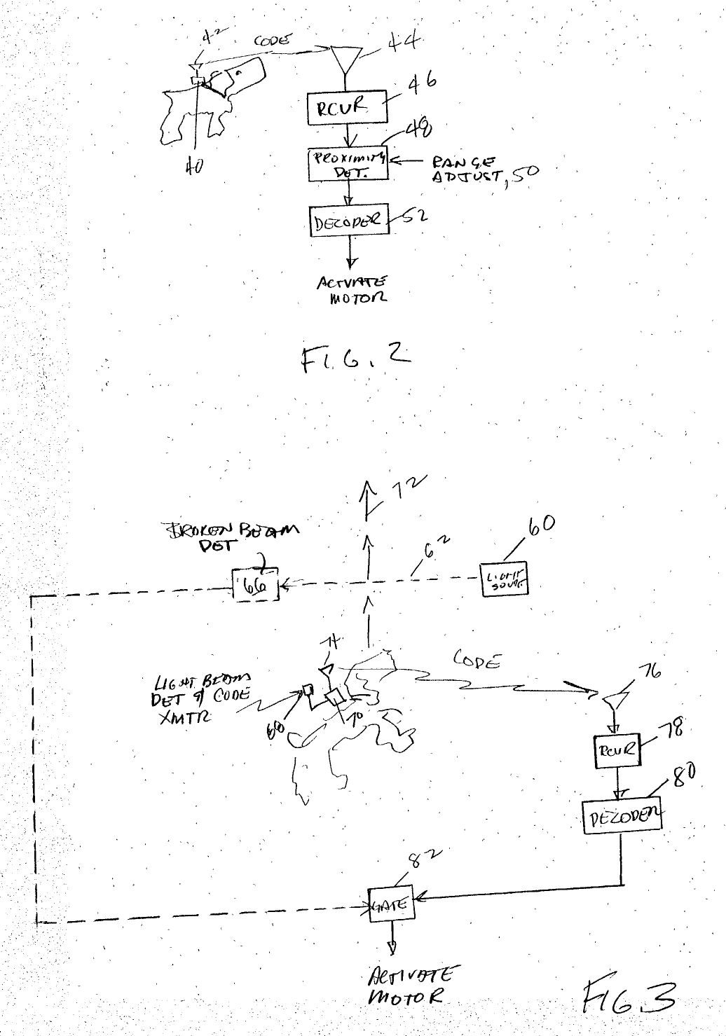

Referring now to FIG. 2, in one embodiment the proximity of the animal to a door is detected by providing the animal with a transmitter 40 which transmits via antenna 42 a coded signal to antenna 44 which is coupled to a receiver 46. The outputted receiver 46 is coupled to a ranging type proximity detector 48 which has a range adjust 50 to set the proximity detector to detect the presence of an animal only when the absolute amplitude of the signal from the transmitter 40 exceeds a predetermined value.

The output of the proximity detector coupled to a decoder 52 for the activation of a motor 12 in FIG. 1.

It will be appreciated that any type of ranging detector can be utilized such as an acoustic ranging detector, a radar ranging detector, or a light pulse ranging detector.

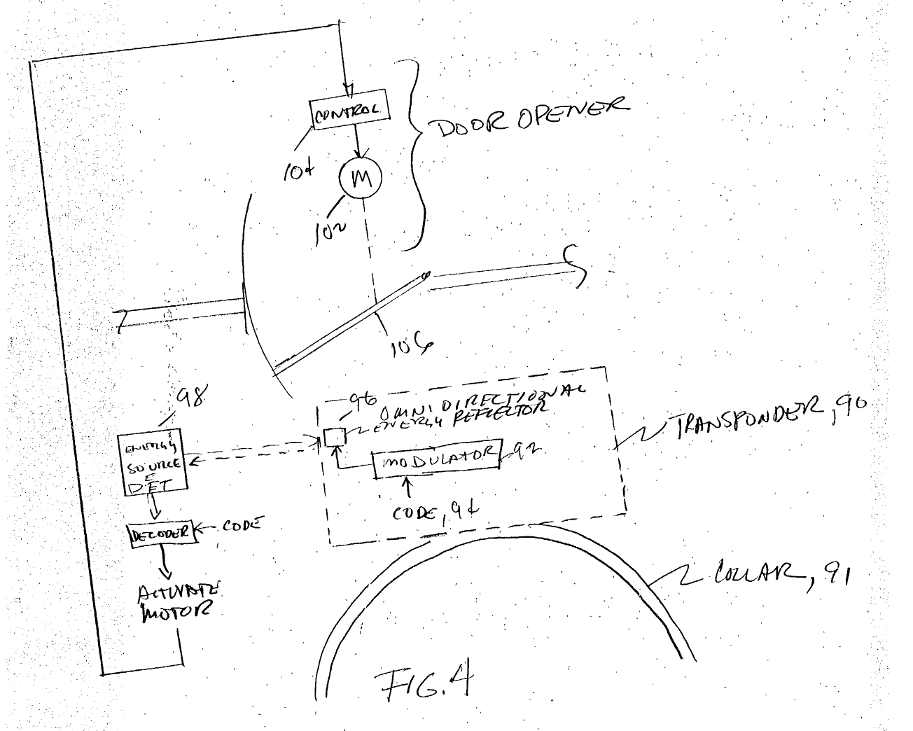

Referring to FIG. 3, a more simplified pet detection system is illustrated in which a collimated light source 60 is utilized to provide a beam 62 toward a broken beam light detector 66. The pet in this case is provided with a light beam detector 68 coupled to a coded signal transmitter 70 which when the light beam is intercepted as the animal moves across the light path illustrated by arrows 72, transmitter 70 is activated to provide a coded signal via antenna 74 to an antenna 76 coupled to receiver 78 which in turn is coupled to a decoder 80.

The output decoder 80 may be utilized to activate motor 12 in FIG. 1 or, for robustness, may be provided to a gate 82 which provides the motor control signal be generated in response to an output from broken beam detector 66.

In this embodiment, the broken beam is what indicates when an animal is ready to go through a door or portal, with the authorization of the animal being provided through the coded transmission 70.

It is also possible to provide a transponder type of identification system such as used on marine buoys when a buoy is interrogated by a radar signal, with the buoy sending back via its transponder not only an indication of its presence but also a number indicating the identity of the buoy.

Regardless of the way in which the presence of the authorized animal is detected it is important that the presence of the animal be detected in the vicinity of the door and that the identity of the animal be detected in terms of a coded transmission from a device located on the animal.

In this manner a door can be permanently shut against the elements, which door automatically opens in response not only to the presence of an animal to either side of the door but also to the presence of an animal which transmits a coded signal to a coded signal detector or decoder so that the door is only operated when in the presence of an animal whose identity is known.

Referring to FIG. 4, a transponder embodiment is shown in which a transponder 90 carried by a pet collar 91 detects and either reflects incoming radiation with a coded modulation thereof from modulator 92 provided with a code 94, or retransmits a return signal via a traveling wave tube 96 back to a collimated source of radiation from a radiator 98. This source also has a detector which detects the incoming modulated radiation that is decoded at 100 and used to activate motor 102 via controller 104. Motor 102 thus opens door 106 in response to the presence of the pet in the collimated beam and the detection of the appropriate code.

The subject system thus eliminates the problems associated with passive flexible flaps which can admit unauthorized animals or indeed humans. Moreover, the system provides the opportunity to completely seal the portal as by the closing of a door as opposed to the prior art use of a flexible flap or panel to seal around the edges of the flap. Since the door can have thermal insulating properties, it is a much more efficient way to keep heat in the house during the winter, and to provide that the cooling available from air conditioning within the house does not leak out during the summer.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method, for providing pet access to and from a dwelling while at the same time excluding ingress and egress to unauthorized animals or individuals, comprising the steps of:
placing on an authorized pet a transmitter which transmits a signal having a predetermined code identifying the authorized pet; and,
automatically opening a door responsive both to the presence of the pet at the door and receipt of the predetermined code.

2. The method of claim 1, wherein the step of automatically opening a door includes sensing the proximity of the pet to the door.

3. The method of claim 2, wherein the proximity sensing step includes the use of ultrasonic energy.

4. The method of claim 2, wherein the proximity sensing steps includes the use of a light beam broken by the presence of the pet.

5. The method of claim 2, wherein the proximity sensing step includes sensing the amplitude of the transmitted signal.

6. The method of claim 2, wherein the transmitter is keyed to transmit responsive to a signal used for sensing the proximity of the pet.

7. The method of claim 6, wherein the keying of the transmitter is based on receipt of an acoustic signal.

8. The method of claim 6, wherein the keying of the transmitter is based on receipt of an signal.

9. The method of claim 6, wherein the keying of the transmitter is based on receipt of light.

10. A system for controlled access of a pet to a dwelling comprising:
a transmitter on an authorized pet which transmits a signal having a predetermined code identifying said authorized pet; and,
a door opener operated responsive both to the presence of said authorized pet in the vicinity of said door and decoding of said coded transmitted signal.

11. The system of claim 10, wherein said door opener includes a pet proximity detector.

12. The system of claim 11, wherein said proximity detector includes means for detecting acoustic energy.

13. The system of claim 11, wherein said proximity detector includes a broken light beam detector.

14. The system of claim 11, wherein said proximity detector includes a signal amplitude detector.

15. The system of claim 11, wherein said transmitter is keyed responsive to receipt of a signal from said proximity detector, thus to function as a transponder.
